(19) United States
(12) Patent Application Publication
(10) Pub. No.: US 2020/0317030 A1
(43) Pub. Date: Oct. 8, 2020

(54) APPARATUS FOR AIR VENT OF VEHICLE

(71) Applicants: HYUNDAI MOTOR COMPANY, SEOUL (KR); KIA MOTORS CORPORATION, SEOUL (KR); ITW EF&C KOREA LLC., INCHEON (KR); HYUNDAI MOBIS CO., LTD., SEOUL (KR)

(72) Inventors: Seok Jun Oh, Gwacheon-si (KR); Jung Mo Kwak, Gunpo-si (KR); Dong Won Yeon, Hwaseong-si (KR); Jong Eun Park, Yongin-si (KR); Yun Ho Choe, Incheon (KR)

(21) Appl. No.: 16/839,312

(22) Filed: Apr. 3, 2020

(30) Foreign Application Priority Data
Apr. 4, 2019 (KR) 10-2019-0039640

(51) Int. Cl. B60H 1/34

(52) U.S. Cl. CPC B60H 1/3421; B60H 2001/3471

(57) ABSTRACT

The present disclosure provides an air vent device including a garnish including an air vent hole, a second wing located inside the air vent hole in a vertical direction, a first wing located at an outer side of the air vent hole in a lateral direction and configured to be pivoted based on one end close to the outer side of the air vent hole, a deco part configured to surround the garnish and at least a portion of an outermost surface of the first wing, and a knob configured to control a direction of a wind discharged from the air vent hole, wherein the knob includes a knob of the first wing capable of adjusting a vertical wind direction by operating the first wing and a knob of the second wing configured to face a rear surface the knob of the first wing.

### CROSS REFERENCE TO RELATED APPLICATIONS

This application claims under 35 U.S.C. § 119(a) the benefit of priority to Korean Patent Application No. 10-2019-0039640 filed on Apr. 4, 2019, the entire contents of which are incorporated herein by reference.

### BACKGROUND

### (a) Technical Field

The present disclosure relates to an air vent device. More particularly, it relates to an air vent device including a deco part disposed in and fixed to a garnish inside a vehicle, providing a first wing inside the deco part and configured to be pivoted based on an outer side of an air vent hole, thereby allowing the deco part, which is configured to surround the garnish even when the first wing is pivoted in a vertical direction, to maintain a predetermined position.

Conventionally, an air vent device having a form, in which a number of second wing plates are vertically arranged and installed in a discharge direction of an air vent hole having a discharge port provided in a front side, a number of first wing plates are laterally arranged and installed at an outer side of an air vent housing, wind direction control knobs are installed on first wings and one second wing to be movable in a lateral direction and a vertical direction, is mainly used in a vehicle.

### (b) Background Art

In the conventional air vent device of the vehicle, when the wind direction control knobs are vertically moved, since each first wing is inclined upward or downward, a direction of air discharged to the discharge port of the air vent hole is controlled in the vertical direction, and, when the wind direction control knobs are laterally moved, since each second wing is inclined in a left direction or a right direction, the direction of the air discharged through the discharge port of the air vent hole is controlled in the lateral direction.

However, since the conventional air vent device of the vehicle is comprised of a plurality of parts so as to install the wind direction control knobs on the first wings to be movable in the lateral direction, many required parts are necessary so that manufacturability and assemblability are difficult, a production cost is high, and an operation is not smooth.

Further, when vertical wind direction control of the first wing is performed in a state in which the first wing is opened, since an outermost surface of the first wing exposed to an interior of the vehicle is increased, there is a problem of aesthetic appearance.

### SUMMARY

The present disclosure has been made in an effort to solve the above-described problems associated with prior art.

In one aspect, the present disclosure provides a deco part located on an outermost surface of a first wing to provide aesthetic stability by providing the deco part of a fixed shape even in vertical wind control.

In another aspect, the present disclosure provides a knob in which a knob of a second wing is integrated with a knob of the first wing to provide an assembly structure with improved workability.

Objectives of the present disclosure are not limited to the above-described objectives, and other objectives of the present disclosure, which are not mentioned, can be understood by the following description and also will be apparently understood through embodiments of the present disclosure. Further, the objectives of the present disclosure can be implemented by means described in the appended claims and a combination thereof.

An air vent device for achieving the above-described objectives of the present disclosure includes the following configuration.

In one aspect, the present disclosure provides an air vent device of a vehicle, which includes a garnish including a discharge port of an air vent hole, a first wing located at an outer side of the air vent hole in one direction and configured to be pivoted based on one end close to the outer side of the air vent hole, a knob configured to control a direction of a wind discharged from the air vent hole, and a deco part configured to surround at least a portion of an opening of the garnish and surround at least a portion of an outermost surface of the first wing.

Further, the air vent device may further include a spacer which is located at each of both ends of the first wing and into which a pivoting shaft of the first wing is inserted.

Further, the air vent device may further include a support member located on rear surface of the deco part and configured to provide support rigidity to the deco part.

Further, the air vent device may further include a recessed part configured to surround the deco part inside the knob.

Further, when the knob is moved vertically, the recessed part may further include a curvature part located to be capable of being spaced a predetermined distance or more apart from the deco part.

Further, the knob may include a knob of the first wing located to surround the deco part and configured to be capable of adjusting a vertical wind direction by operating the first wing, and a second wing knob located inside the deco part and configured to face a rear surface of the knob of the first wing and to be capable of adjusting a lateral wind direction by operating the second wing located inside the air vent hole.

Further, the first wing may further include a protrusion engaged with the knob of the first wing.

Further, the air vent device may further include a first rubber located at one end facing the protrusion and the knob of the first wing.

Further, separation lines may be formed between a plurality of separated portions constituting the deco part based on the protrusion.

Further, the air vent device may further include a second rubber located at a position at which the knob of the first wing faces the knob of the second wing.

Further, an outermost surface of the first wing may be configured in a circular shape based on a pivoting shaft of the first wing.

Further, when the first wing is pivoted vertically, the deco part may be located to face the circular outermost surface of the first wing.

In another aspect, the present disclosure provides an air vent device of a vehicle, which includes a garnish including a discharge port of an air vent hole, a first wing located at an outer side of the air vent hole in one direction and configured to be pivoted based on one end close to the outer side of the air vent hole, a knob configured to control a direction of a wind discharged from the air vent hole, and a deco part configured to surround at least a portion of an opening of the garnish and surround at least a portion of an outermost surface of the first wing, wherein a height of a cross section of the deco part configured to extend from an outermost surface of the first wing is configured to be lower along a direction in which the deco part extends.

Further, separation lines formed between a plurality of separated portions constituting the deco part may be configured to be located inside the knob.

Further, the knob may include a knob of the first wing located to surround the deco part and configured to be capable of adjusting a vertical wind direction by operating the first wing, and a second wing knob located inside the deco part and configured to face a rear surface of the knob of the first wing and to be capable of adjusting a lateral wind direction by operating the second wing located inside the air vent hole.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles

### BRIEF DESCRIPTION OF THE FIGURES

The above and other features of the present disclosure will now be described in detail with reference to certain exemplary embodiments thereof illustrated the accompanying drawings which are given hereinbelow by way of illustration only, and thus are not limitative of the present disclosure, and wherein:

FIG. 1 is a diagram illustrating parts of an air vent device according to one embodiment of the present disclosure;

FIG. 2 is a diagram illustrating a coupling relationship between components of the air vent device according to one embodiment of the present disclosure;

FIG. 3 is a cross-sectional view taken along line A-A of FIG. 2 of the air vent device according to one embodiment of the present disclosure;

FIG. 4A is a cross-sectional view illustrating a configuration of a knob of the air vent device according to one embodiment of the present disclosure;

FIG. 4B is a cross-sectional view illustrating when the configuration of the knob of the air vent device is moved upward according to one embodiment of the present disclosure;

and

FIG. 5 is a cross-sectional view taken along line B-B of FIG. 2 of the air vent device according to one embodiment of the present disclosure.

It should be understood that the appended drawings are not necessarily to scale, presenting a somewhat simplified representation of various preferred features illustrative of the basic principles of the present disclosure. The specific design features of the present disclosure as disclosed herein, including, for example, specific dimensions, orientations, locations, and shapes will be determined in part by the particular intended application and use environment.

In the figures, reference numbers refer to the same or equivalent parts of the present disclosure throughout the several figures of the drawing.

### DETAILED DESCRIPTION

Hereinafter, embodiments of the present disclosure will be described in detail with reference to the accompanying drawings. The embodiments of the present disclosure can be modified in various forms, and the scope of the present disclosure should not be construed as being limited to the following embodiments. These embodiments are provided to more fully describe the present disclosure to those skilled in the art.

The terms “˜part,” “˜device,” “˜member,” and the like used herein mean a unit for processing at least one function or operation, and this unit may be implemented by hardware or a combination thereof.

Further, in the present specification, the terms a first, a second, and the like are assigned to components so as to discriminate these components because names of the components are the same, but these terms are not necessarily limited to the order in the following description.

Further, a “first wing” and a “second wing” may be described herein as one unit including one or more plates.

Further, in the present specification, a “front” means a front surface of a vehicle, and a “rear” means a rear surface of the vehicle as relative positions.

Further, in the present specification, it may be construed that an “inner side” of an air vent hole means a front side, and an “outer side” thereof means a rear side.

The present disclosure relates to an air vent device 100 including a plurality of second wings 120 and a plurality of first wings 130, and provides a technique capable of setting a lateral direction of a wind discharged from an air vent hole 110 by operating the second wings 120 through one knob 140 and setting a vertical direction of the wind discharged from the air vent hole 110 by operating the first wings 130 through the same knob 140.

Further, the present disclosure provides the air vent device 100 configured such that a garnish 200 located on a crash pad of a vehicle and configured to surround the air vent hole 110 and a deco part 150 located to cross the air vent hole 110 in a width direction of the vehicle, and an outermost surface 134, which is exposed to an inner surface of the vehicle even in vertical movements of the first wings 130, consistently includes the deco part 150.

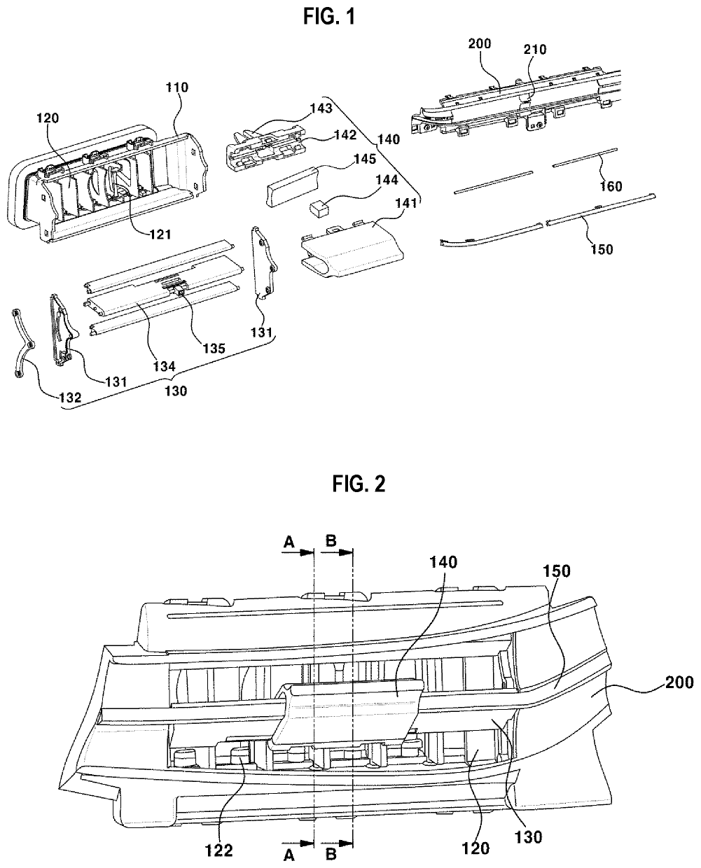

FIGS. 1 and 2 illustrate a configurational diagram of the air vent device 100 of the present disclosure.

The air vent device 100 of the present disclosure is configured to be located by being inserted into the crash pad of the vehicle such that the air vent hole 110 is included in the garnish 200 forming an outer surface of the crash pad.

The air vent hole 110 may be configured to have a predetermined length in a length direction of the vehicle and include an opening on one surface of the air vent hole 110 facing an interior of the vehicle. The air vent hole 110 includes the first wing 130 formed of one or more plates formed at a position close to a rear surface of the vehicle in the air vent hole 110 in one direction of the vehicle, and the second wing 120 formed of one or more plates configured to have a predetermined angle with respect to one direction of the first wing 130 at a position close to a front surface of the vehicle in the air vent hole 110.

More preferably, in one embodiment of the present disclosure, the first wing 130 may be located in a lateral direction of the vehicle, and the second wing 120 may be located in a vertical direction of the vehicle.

Both ends of the first wing 130 include spacers 131 formed to fix one or more plates to the both ends thereof. Preferably, the spacers 131 are configured to fix one or more plates located at the both ends of the air vent hole 110 to form the first wing 130.

More preferably, the spacers 131 are engaged with rear link members 132 located on side surfaces of the spacers 131. Thus, the spacers 131 are configured to connect one or more plates such that the one or more plates forming the first wing 130 are simultaneously moved according to movement of the knob 140.

One or more plates forming the second wing 120 include a front link member 122 located at least a portion of an upper end or a lower end of the second wing 120. Thus, the front link member 122 is configured to allow the one or more plates to be simultaneously moved to a left side and a right side.

The knob 140 may include a first wing knob 141 exposed to the interior of the vehicle and a second wing knob 142 facing and engaged with the first wing knob 141 and configured to be engaged with the second wing 120. The second wing knob 142 includes an engagement part 143 to be engaged with a fixing part 121 of the one or more plates constituting the second wing 120.

Therefore, the movement of the knob 140 is transferred to the second wing 120 through the fixing part 121 engaged with the engagement part 143, and the one or more plates connected by the front link member 122 are pivoted in a lateral direction at a predetermined angle in response to a lateral movement of the knob 140.

The first wing knob 141 is configured to be engaged with the second wing knob 142 by being adjacent thereto in the length direction of the vehicle and extends to the inner surface of the vehicle. Thus, an inner surface of the first wing knob 141 is configured to be engaged with a protrusion 135 of the first wing 130, and the first wing knob 141 is configured to be engaged with the second wing knob 142 to surround the protrusion 135.

Further, the first wing knob 141 includes the deco part 150 located in the width direction of the vehicle based on the protrusion 135. Thus, the first wing knob 141 is configured to surround the deco part 150.

The first wing knob 141 is configured to be engaged with the protrusion 135 of the first wing 130 such that a plurality of lateral plates constituting the first wing 130 are integrally pivoted in the vertical direction according to a vertical movement of the first wing knob 141.

Preferably, one or more lateral plate pivoting shafts 133 rotating according to the first wing knob 141 are configured to be located on both side surfaces close to the air vent hole 110 and the interior of the vehicle and configured to allow one ends of the plurality of lateral plates close to the front surface of the vehicle to be pivoted in response to the vertical movement of the first wing knob 141 based on the one or more lateral plate pivoting shafts 133.

That is, the outermost surface 134 of the first wing 130, which face the interior of the vehicle is configured to be kept constant and configured to allow one end of the first wing 130 to be pivoted. More preferably, in order to make an area in which the outermost surface 134 of the first wing 130 and the deco part 150 face to each other constant, the other end of the first wing 130 may be configured such that the outermost surface 134 has a semicircular cross section based on the lateral plate pivoting shaft 133.

Further, the deco part 150 is disposed on the other end of the first wing 130, at which the lateral plate pivoting shaft 133 of the first wing 130 is located, to surround at least a portion of the outermost surface 134 of the first wing 130. Thus, the deco part 150 provides a fixed shape even in a vertical pivoting of the first wing 130.

The present disclosure, the deco part 150 and the first wing 130 are independently located so that the deco part 150 is configured to not interfere with movement of the first wing 130. The deco part 150 is configured to be located to cross the garnish 200 including the air vent hole 110 in the lateral direction, configured to have a length greater than or equal to a width of the air vent hole 110, and configured to surround an entirety of a width of the garnish 200.

Preferably, in one embodiment of the present disclosure, the garnish 200 is configured to include two air vent holes 110 and the deco part 150 is configured to cross each of the two air vent holes 110. Thus, a separation line of the deco part 150 comprised of three separated portions is configured to be located on inner surfaces of two knobs 140 and configured to not be exposed to the outside.

More preferably, the deco part 150 comprised of three separated portions may be configured to be located in the width direction of the vehicle based on the protrusion 135 of the first wing 130, and the separation line of the deco part 150 may be configured to be located adjacent to the protrusion 135 of the first wing 130.

The deco part 150 is located to cross the two air vent holes 110. Thus, the deco part 150 may be configured to be fixed to a central support 210 of the garnish 200 located between the two air vent holes 110.

The deco part 150 is configured to be supported on the garnish 200 located on an outer circumference of the air vent hole 110 instead of being fixed to the outermost surface 134 of the first wing 130. Thus, in order to secure support rigidity of the deco part 150, the deco part 150 may further include a support member 160 located on a rear surface of the deco part 150. In one embodiment of the present disclosure, the support member 160 is formed of a steel pin. The steel pin may be configured to be inserted or pressed into the deco part 150.

Preferably, the deco part 150 of the present disclosure may be configured to extend in an interior direction of the vehicle along the outermost surface 134 of the first wing 130, and a height (vertical width) of a cross section of the deco part 150 may be configured to be decreased (narrower) toward the interior direction of the vehicle. More preferably, in one embodiment of the present disclosure, the deco part 150 is configured to surround at least a portion of the outermost surface 134 of the first wing 130 and include a protruding shape to extend to a vertex spaced toward a rear side of the vehicle based on the outermost surface 134. That is, the cross section of the deco part 150 is configured such that the height of the cross section thereof becomes decreased toward the rear side of the vehicle.

The deco part 150 is configured to have a protruding cross section based on the outermost surface 134 of the first wing 130, and thus a shape of the deco part 150 is not limited.

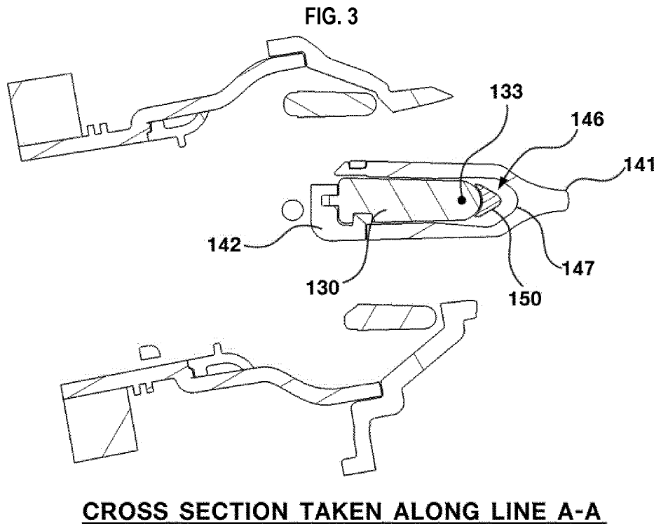

FIG. 3 is a cross-sectional view taken along line A-A of the air vent device according to one embodiment of the present disclosure.

As shown in the drawing, the knob 140 of the present disclosure is configured such that at least a portion thereof is located at an outer side of a discharge port of the air vent hole 110, preferably, at least a portion of the first wing knob 141 is located at the outer side thereof.

The air vent hole 110 is located in the length direction from the front side to the rear side of the vehicle, and the garnish 200 configured to surround at least a portion of the crash pad is configured to surround the discharge port of the air vent hole 110 facing the interior of the vehicle.

More preferably, the air vent hole 110 includes an opening and is configured such that the opening is surrounded by the garnish 200.

The first wing knob 141 is configured to surround a portion of the first wing 130 and includes a recessed part 146 configured at a position surrounding the first wing 130 in the length direction. The recessed part 146 is configured to surround portions of the first wing 130 and the deco part 150 and include a curvature part 147 at one end of the recessed part 146 close to the deco part 150 so as to prevent the first wing 130 and the deco part 150 from interfering with a vertical movement of the knob 140.

The first wing knob 141 is configured to face and be engaged with the second wing knob 142 located at one end of the first wing knob 141 close to the front surface of the vehicle. Thus, the second wing knob 142 and the first wing knob 141 are configured to be located to surround the first wing 130.

The first wing 130 includes the lateral plate pivoting shaft 133 configured on both side surfaces thereof at a position adjacent to the deco part 150 in the width direction of the vehicle and one end of the first wing 130 close to the front surface of the vehicle is configured to be vertically pivoted based on the lateral plate pivoting shaft 133 according to the vertical movement of the knob 140.

When the first wing 130 is pivoted, the deco part 150 is supported on the garnish 200 and configured to be located independently from the movement of the first wing 130. Preferably, the outermost surface 134 of the first wing 130 in the interior direction of the vehicle is configured in a circular shape so as to not interfere with one surface facing the deco part 150 when the first wing 130 is vertically pivoted.

The curvature part 147 is configured to be located at a distal end of the recessed part 146 into which the deco part 150 is laterally inserted, and the configuration of the deco part 150, which is not pivoted corresponding to a pivoting radius of the first wing knob 141 pivoted in the vertical direction, is located in an area which does not interfere with an inner surface of the recessed part 146 of the first wing knob 141. More preferably, the curvature part 147 may be determined to correspond to the shape of the deco part 150 and the movement of the first wing knob 141 which is configured to be moved in the vertical direction.

Further, the curvature part 147 is configured such that the deco part 150 and the inner surface of the first wing knob 141 do not interfere with each other according to heights at a highest point and a lowest point of the first wing knob 141. Thus, the curvature part 147 may be comprised of two or more areas having different curvatures.

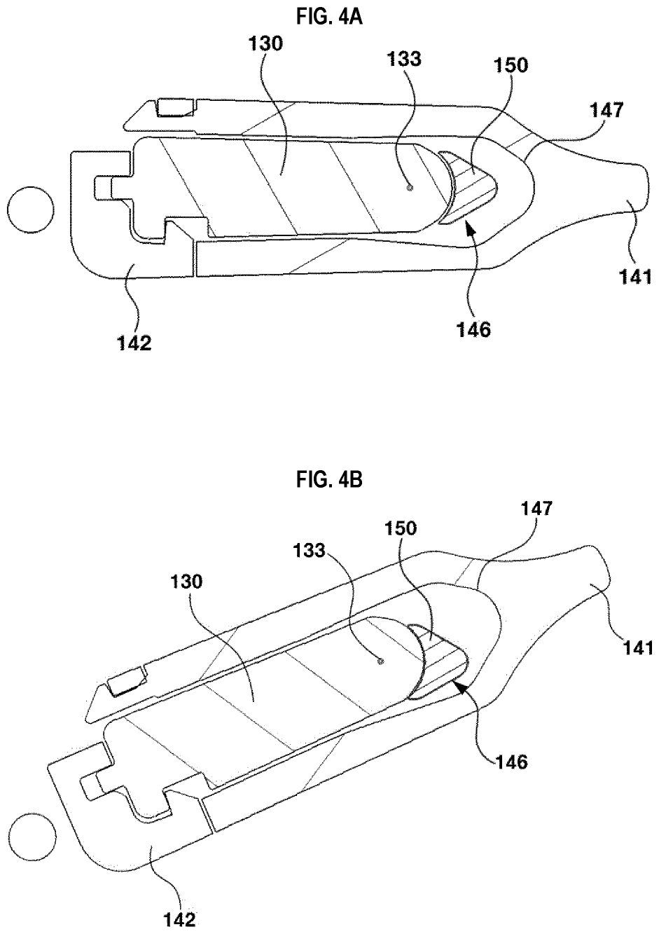

FIG. 4A illustrates a cross-sectional view of a configuration of the knob 140 according to one embodiment of the present disclosure.

As shown in the drawing, a cross-sectional view in a state in which the first wing 130 is parallel to the air vent hole 110 is illustrated. The knob 140 includes the first wing 130 which is configured such that one end of the first wing 130 adjacent to the front surface of the vehicle is pivoted at a position close to the opening of the air vent hole 110 based on the lateral plate pivoting shaft 133, and the deco part 150 configured to be adjacent to the outermost surface 134 of the first wing 130 facing the interior of the vehicle and to be supported on the garnish 200.

The outermost surface 134 of the first wing 130 is configured to be moved independently from the deco part 150. Thus, the first wing 130 may be spaced a predetermined interval apart from the deco part 150, or the first wing 130 and the deco part 150 may be located to be in contact with each other so as to allow an independent movement.

Further, the outermost surface 134 of the first wing 130 is configured to have a circular cross section based on the lateral plate pivoting shaft 133 so that the first wing 130 may be configured to be pivoted without mutual interference with the deco part 150 which is fixed and located.

As compared with FIG. 4A, FIG. 4B illustrates a coupling relationship between the components when the knob 140 is located at the highest point in a height direction.

FIG. 4B illustrates a cross-sectional view of a state in which a wind direction of the air vent hole 110 is adjusted upward and discloses a configuration in which the knob 140 is located at the highest point.

When the knob 140 is located at the highest point, one ends, which are close to the discharge part of the air vent hole 110, of one or more plates constituting the first wing 130 are pivoted to positions that are higher than those of the other ends thereof close to the front surface of the vehicle.

More preferably, the first wing 130 including one or more plates is configured to interlock with the knob 140 according to an operation of the knob 140. When the one or more plates which are physically coupled to the first wing knob 141 are moved vertically, the one or more plates located in parallel with each other are configured to interlock with one plate that is engaged with the first wing knob 141 by the spacers 131 and the rear link members 132.

As shown in the drawing, one end of the first wing 130 close to the front surface of the vehicle is configured to be pivoted based on the lateral plate pivoting shaft 133 fixed at a position close to openings of both side surfaces of the air vent hole 110. Thus, when the knob 140 is located at the highest point, the other end of the first wing 130 close to the front surface of the vehicle is configured to be located at the lowest point.

Further, the deco part 150 which is fixed independently from the movement of the first wing 130 is included on one surface of the first wing 130, which is pivoted based on the lateral plate pivoting shaft 133, in the length direction. The deco part 150 is located in the recessed part 146 on the inner surface of the knob 140 so as to not interfere with the movement of the knob 140 according to the movement of the first wing 130. More preferably, the curvature part 147 is configured to be included at one end of the part 146 such that the movement of knob 140 does not interfere with the fixed deco part 150.

As described above, even when the first wing 130 is pivoted vertically, the deco part 150 may be maintained a fixed position without interfering with the knob 140 due to the recessed part 146 and the curvature part 147 located inside the knob 140. Thus, the deco part 150 exposed to the interior of the vehicle or at least a portion of the first wing 130 including the deco part 150 is configured to be constantly maintained.

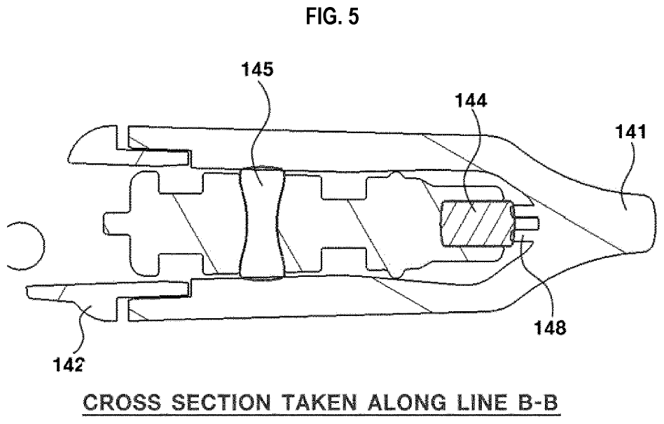

FIG. 5 illustrates a cross-sectional view showing a coupling relationship between the components of the first wing knob 141 engaged with the protrusion 135 of the first wing 130 according to one embodiment of the present disclosure.

At least one plate of the first wing 130 formed of one or plates is configured to be engaged with the first wing knob 141.

As described above, the at least one plate engaged with the first wing knob 141 is configured to be moved integrally with another adjacent plate through the spacers 131 and the rear link members 132 in response to the movement of the first wing knob 141. Thus, one ends of plates close to the front surface of the vehicle are moved in a direction opposite a movement direction of the first wing knob 141.

Further, the plate on which the protrusion 135 is located may include the deco part 150 comprised of three separated portions in the width direction of the vehicle based on the protrusion 135. Thus, a separation line comprised of two separated portions is configured to be surrounded by the knob 140.

Therefore, a position of the separation line of the separated objects constituting the deco part 150 is configured to not be exposed to the interior direction of the vehicle.

More preferably, the deco part 150 may be configured to include separation lines equal to the number of knobs 140. Thus, in one embodiment of the present disclosure including two knobs 140, a deco part 150 formed of a coupling of three separated portions may be configured.

The deco part 150 of the present disclosure may be configured to be continuously located in the crash pad of the vehicle. More preferably, the shape of the deco part 150 may be included to be continuously located to surround the inner surface of the vehicle.

Further, one end of the deco part 150 facing the protrusion 135 and the first wing knob 141 may include a first rubber 144. Thus, the first rubber 144 is configured to absorb a vibration and noise generated according to the movement of the first wing knob 141.

Further, a second rubber 145 located at a position at which the first wing knob 141 faces the second wing knob 142. Thus, the second rubber 145 may absorb a vibration and noise generated due to the two configurations coupled according to the movement of the knob 140.

As described above, the present disclosure includes the air vent hole 110 having the deco part 150 and provides the configuration of the knob 140 capable of adjusting the wind directions of the first wing 130 and the second wing 120 based on the deco part 150 of a fixed shape.

The present disclosure can obtain the following effects according to the above-described configuration, combination, and use relationship.

The present disclosure provides a deco part of a fixed shape to an interior of a vehicle even when a first wing is adjusted vertically and has an effect of providing aesthetic stability to a passenger of the vehicle.

Further, the present disclosure provides a knob capable of integrally adjusting a first wing and a second wing and has an effect of improving usability.

Further, the present disclosure provides an integrally configured garnish and an improvement effect of an assembly process of an air vent device.

The foregoing detailed description illustrates the present disclosure. Further, the foregoing is intended to illustrate and describe the exemplary embodiments of the present disclosure, and the present disclosure may be used in various other combinations, modifications, and environments. That is, it is possible to make alternations or modifications without departing from the scope of the present disclosure disclosed in this disclosure, equivalents, and/or within the technical or knowledge scope in the art to which the present disclosure pertains. The described embodiments are intended to illustrate the best mode for carrying out the technical spirit of the present disclosure and various modification can made in the specific applications and uses of the present disclosure. Therefore, the detailed description is not intended to limit the present disclosure as in the disclosed embodiments. Further, it should be construed that the appended claims are intended to include another embodiment.

1. An air vent device of a vehicle, comprising:
a garnish including a discharge port of an air vent hole;
a first wing located at an outer side of the air vent hole in one direction and configured to be pivoted based on one end close to the outer side of the air vent hole;
a knob configured to control a direction of a wind discharged from the air vent hole; and
a deco part configured to surround at least a portion of an opening of the garnish and surround at least a portion of an outermost surface of the first wing.

2. The air vent device of claim 1, further comprising:
a spacer which is located at each of both ends of the first wing and into which a pivoting shaft of the first wing is inserted.

3. The air vent device of claim 1, further comprising:
a support member located on rear surface of the deco part and configured to provide support rigidity to the deco part.

4. The air vent device of claim 1, further comprising:
a recessed part configured to surround the deco part inside the knob.

5. The air vent device of claim 4, wherein, when the knob is moved vertically, the recessed part further includes a curvature part located to be capable of being spaced a predetermined distance or more apart from the deco part.

6. The air vent device of claim 1, wherein the knob includes:
a knob of the first wing located to surround the deco part and configured to be capable of adjusting a vertical wind direction by operating the first wing; and
a knob of the second wing located inside the deco part and configured to face a rear surface of the knob of the first wing and to be capable of adjusting a lateral wind direction by operating the second wing located inside the air vent hole.

7. The air vent device of claim 6, wherein the first wing further includes a protrusion engaged with the knob of the first wing.

8. The air vent device of claim 7, further comprising:
a first rubber located at one end facing the protrusion and the knob of the first wing.

9. The air vent device of claim 7, wherein separation lines are formed between a plurality of separated portions constituting the deco part based on the protrusion.

10. The air vent device of claim 6, further comprising:
a second rubber located at a position at which the knob of the first wing faces the knob of the second wing.

11. The air vent device of claim 1, wherein an outermost surface of the first wing is configured in a circular shape based on a pivoting shaft of the first wing.

12. The air vent device of claim 11, wherein, when the first wing is pivoted vertically, the deco part is located to face the circular outermost surface of the first wing.

13. An air vent device of a vehicle, comprising:
a garnish including a discharge port of an air vent hole;
a first wing located at an outer side of the air vent hole in one direction and configured to be pivoted based on one end close to the outer side of the air vent hole;
a knob configured to control a direction of a wind discharged from the air vent hole; and
a deco part configured to surround at least a portion of an opening of the garnish and surround at least a portion of an outermost surface of the first wing,
wherein a width of a cross section of the deco part configured to extend from an outermost surface of the first wing is configured to be narrow along a direction in which the deco part extends.

14. The air vent device of claim 13, wherein separation lines formed between a plurality of separated portions constituting the deco part are configured to be located inside the knob.

15. The air vent device of claim 13, wherein the knob includes:
a knob of the first wing located to surround the deco part and configured to be capable of adjusting a vertical wind direction by operating the first wing; and
a second wing knob located inside the deco part and configured to face a rear surface of the knob of the first wing and to be capable of adjusting a lateral wind direction by operating the second wing located inside the air vent hole.
